(19) United States
(12) Patent Application Publication
(10) Pub. No.: US 2007/0103837 A1
(43) Pub. Date: May 10, 2007

(54) Circuit device to prevent function of electronic equipment or appliance from attenuating

(76) Inventor: Yao-Nan Chou, Hemei Township (TW)

Correspondence Address: TROXELL LAW OFFICE PLLC, SUITE 1404, 5205 LEESBURG PIKE, FALLS CHURCH, VA, 22041, US

(21) Appl. No.: 11/266,270

(22) Filed: Nov. 4, 2005

(51) Int. Cl. H02H 9/06

(52) U.S. Cl. 361/118

(57) ABSTRACT

A circuit device to prevent electronic equipment or appliance from attenuating, which connect power to equipment or appliance, meanwhile, connect parallelly with serial connected circuit of current limiting resistance and metal oxide film transistor so as to make an anti-attenuation circuit, application of this parallel connected anti-attenuation circuit can reduce AC resistance of whole equipment, signal output by amplifier can conduct metal oxide film transistor, AC noise power contained is filtered by grounding of current limiting resistance and metal oxide film transistor, so that this power provided hasn't noise jamming and components around may not be radiated, therefore, acoustic product can obtain better fidelity, gasoline molecule isn't jammed by noise, and may combust with air effectively but not reduce its combustion efficiency.

### BACKGROUND OF THE INVENTION

1) Field of the Invention

This invention relates to a circuit device to prevent function of electronic equipment or appliance from attenuating, which is to parallelly connect an anti-attenuation circuit to electronic equipment or appliance in order to reduce AC resistance of overall loop and filter AC noise, so that acoustic products can obtain better fidelity of music source, gasoline molecule can't be damaged due to noise jamming, therefore, gasoline may combust with air effectively but not reduce its combustion efficiency.

2) Description of the Prior Art

Usually, most of common electronic equipments and appliances often apply filter to get rid of noise in order to perform their best function, on one hand, it can avoid jamming appliances or electronic equipments around, on the other hand, it may expose better stable function and efficiency, however, power not only has AC noise, also contains radiation of electromagnetic wave, which is generally called AC noise.

### SUMMARY OF THE INVENTION

1. Problem to Solve:

(1) Usually, a filter circuit is parallely connected to power end of an electronic equipment or appliance in order to filter noise. However, it is impossible to actually get rid of noise and reach best results, because power still keeps electromagnetic wave and noise that cannot be filtered actually, which may jam this electronic equipment or appliance, so that electronic equipment, such as fidelity of automobile acoustic products, may produce noise or make audio frequency attenuate.

(2) The radiated signal of this AC noise, if close to liquid, may change molecule of this liquid; therefore, if apply it for automobile control circuit, may radiate this noise and damage molecule arrangement of gasoline so as to cause incomplete combustion.

2. Solutions:

(1) This invention is to connect parallelly an anti-attenuation circuit to power end of electronic equipment or appliance, which is composed of amplifier, current limiting resistance and metal oxide film transistor; wherein input ends of this amplifier and current limiting resistance are connected with the power, output end of amplifier is connected with contact end of metal oxide film transistor, output end of this current limiting resistance is connected with input end of metal oxide film transistor, and let output ends of amplifier and metal oxide film transistor ground respectively, meanwhile, according to its type, this electronic equipment can be connected parallelly with several groups of metal oxide film transistors so that signal outputted by amplifier can conduct several groups of metal oxide film transistors at the same time. The above described anti-attenuation circuit which is connected to the power can reduce AC resistance of this equipment, so that AC noise is grounded from current limiting resistance through metal oxide film transistor, and all noises are thoroughly filtered, this connected electronic equipment or appliance has no jamming, therefore, it can produce best function accordingly.

(2) The above described function, if provide to acoustic product, may obtain better fidelity of music source, and also gasoline molecule can't be damaged due to noise jamming, so, it may completely combust and promote efficiency accordingly.

### BRIEF DESCRIPTION OF THE DRAWINGS

FIG. 1 is the anti-attenuation circuit diagram of this invention.

FIG. 2 is the anti-attenuation extended circuit diagram

### DETAILED DESCRIPTION OF THE PREFERRED EMBODIMENTS

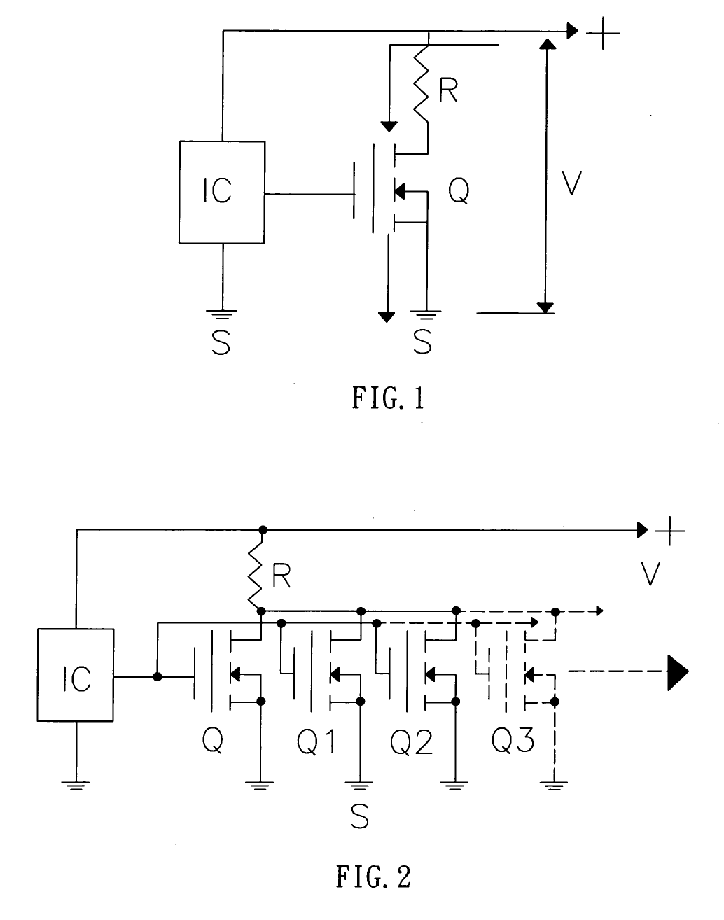

Please refer to FIG. 1, which is to connect parallelly an anti-attenuation circuit PC with power end V of electronic equipment or appliance; this anti-attenuation circuit 1 is composed of amplifier, current limiting resistance R and metal oxide film transistor Q; wherein input ends of amplifier IC and current limiting resistance R are connected to power V, and output end of amplifier is connected with contact end of metal oxide film transistor, output end of this current limiting resistance is connected with input end of metal oxide film transistor, and let output ends of amplifier IC and metal oxide film transistor ground S respectively; please refer to FIG. 2, above described anti-attenuation circuit 1, according to its type, is parallelly connected with metal oxide film transistor Q,Q1,Q2,Q3 . . . so that signal outputted by amplifier IC can conduct several groups of metal oxide film transistor Q,Q1,Q2,Q3 . . . at the same time. The above described anti-attenuation circuit 1, if parallelly connect to power V, may reduce AC resistance of this equipment, let AC noise ground S from current limiting resistance through metal oxide film transistor Q, Q1,Q2,Q3 . . . so as to filter completely all noise, this connected electronic equipment or appliance has no jamming, therefore, it can produce best function accordingly.

The above described device can be applicable for all electronic equipments, but not only limited in home appliance. In order to embody the purpose of this invention, herein take automobile acoustic product as example, namely, it can filter AC noise of automobile so as to promote fidelity of music source; in addition, filtering AC noise may not damage gasoline molecule so that gasoline can be combusted completely.

What is claimed is:

1. A circuit device to prevent electronic equipment or appliance from attenuating, which is an anti-attenuation circuit that is connected to power so as to reduce AC resistance of whole equipment, this AC noise is easy to be filtered, its features are as follows:
Input ends of this amplifier and current limiting resistance are connected to power of electronic equipment or appliance, output end of amplifier is to connect with contact end of metal oxide film transistor, output end of this current limiting resistance is connected with input end of metal oxide film transistor, and let output ends of amplifier and metal oxide film transistor ground respectively; the start power provided can let amplifier output signal and conduct metal oxide film transistor so as to completely filtered AC noise through this path, therefore, it can produce best function accordingly.

2. As claimed in claim 1, it is a circuit device to prevent electronic equipment or appliance from attenuating, wherein output end of current limiting resistance, according to type of this electronic equipment, is connected parallelly with several groups of metal oxide film transistor, and output end of amplifier is connected to contact end of several groups of metal oxide film transistors at the same time so as to output signal and conduct several groups of metal oxide film transistors, AC resistance of this equipment can be reduced, therefore, AC noise is filtered by grounding from current limiting resistance through metal oxide film transistor.

3. As claimed in claim 1, it is a circuit device to prevent electronic equipment or appliance from attenuating, wherein this anti-attenuation circuit can be connected with power of automobile acoustic product and filter AC noise of automobile so as to improve fidelity of music source.

4. As claimed in claim 1, it is a circuit device to prevent electronic equipment or appliance from attenuating, wherein this anti-attenuation circuit can filter completely AC noise, so that gasoline molecule is not damaged, gasoline may be completely combusted.
